(19) United States
(12) Patent Application Publication
(10) Pub. No.: US 2025/0370395 A1
(43) Pub. Date: Dec. 4, 2025

(54) CONNECTOR MODULE, WRITING UNIT, AND IMAGE FORMING APPARATUS

(71) Applicant: Naoki KIKUCHI, Kanagawa (JP)

(72) Inventor: Naoki KIKUCHI, Kanagawa (JP)

(73) Assignee: Ricoh Company, Ltd., Tokyo (JP)

(21) Appl. No.: 19/203,547

(22) Filed: May 9, 2025

(30) Foreign Application Priority Data
May 30, 2024 (JP) 2024-088167

(51) Int. Cl. G03G 15/00; B41J 2/44; G03G 15/04; H01R 24/60

(52) U.S. Cl. CPC G03G 15/80; B41J 2/442; G03G 15/04072; H01R 24/60

(57) ABSTRACT

A connector module includes a connector having multiple connection terminals including: a first connection terminal to transmit a drive signal; and second connection terminals not used to transmit the drive signal; a transmission signal line connected to the first connection terminal to transmit the drive signal to the first connection terminal; and a bent signal line connected to the second connection terminals. The bent signal line has both ends connected to the second connection terminals; and a fold part between the both ends.

### CROSS-REFERENCE TO RELATED APPLICATIONS

This patent application is based on and claims priority pursuant to 35 U.S.C. § 119(a) to Japanese Patent Application No. 2024-088167, filed on May 30, 2024, in the Japan Patent Office, the entire disclosure of which is hereby incorporated by reference herein.

### BACKGROUND

### Technical Field

The present disclosure relates to a connector module, a writing unit, and an image forming apparatus.

### Related Art

An image forming apparatus is known as an example of a device equipped with multiple processing units. For example, an image forming apparatus includes an image writing control unit as a control unit that controls image write operations, and a writing unit as an execution unit that performs image write operations to form images on media.

### SUMMARY

An embodiment of the present disclosure provides a connector module including a connector having multiple connection terminals including: a first connection terminal to transmit a drive signal; and second connection terminals not used to transmit the drive signal; a transmission signal line connected to the first connection terminal to transmit the drive signal to the first connection terminal; and a bent signal line connected to the second connection terminals. The bent signal line has both ends connected to the second connection terminals; and a fold part between the both ends.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram of an image forming apparatus;

FIG. 2 is a schematic diagram illustrating a configuration of a writing unit;

FIGS. 3A and 3B are schematic diagrams each illustrating a configuration of a writing unit;

FIG. 4 is a block diagram of a functional configuration of a writing unit according to an embodiment of the present disclosure;

FIG. 5 is a block diagram of a functional configuration of a writing unit according to a comparative example;

FIG. 6 is a block diagram of a functional configuration of a writing unit according to an embodiment of the present disclosure;

FIG. 7 is a block diagram of a functional configuration of a connector module according to an embodiment of the present disclosure;

FIG. 8 is a block diagram of a functional configuration of a connector module according to an embodiment of the present disclosure;

FIG. 9 is a block diagram of a configuration of a connector module according to an embodiment of the present disclosure;

FIG. 10 is a block diagram of a configuration of a connector module according to a comparative example;

FIG. 11 is a block diagram of a configuration of a connector module according to an embodiment of the present disclosure; and

FIG. 12 is a block diagram of a configuration of a connector module according to an embodiment of the present disclosure.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

In an image forming apparatus, the number of signal lines used to connect with the control unit differs between the writing unit for forming color images and the writing unit for forming monochrome images. Consequently, the number of signal lines included in the connectors also differs between the color unit and the monochrome unit. If the control unit uses a common connector for both, the connection state may vary depending on whether a color writing unit or a monochrome writing unit is connected, potentially resulting in connector connection failures.

An image forming apparatus equipped with a configuration for detecting connector connection failures is known. In this configuration, one connector includes a No. 1 connection terminal connected to a control unit and a No. n connection terminal that receives a pull-up signal. The other connector includes a loop signal line (also called a bent signal line) that electrically connects the No. 1 terminal to the No. n terminal. With this configuration, if the connectors are properly connected, the pull-up signal is transmitted to the control unit via the loop signal line. If a connection failure occurs, the loop signal line is not connected to either the No. 1 terminal or the No. n terminal, so the control unit does not receive the pull-up signal, thus detecting the failure.

In an image forming apparatus, to reduce costs and standardize the production line, a control unit that controls the operation of each component may be designed to connect to either of two units having different configurations. In such cases, it is desirable to use a common connector for both units, regardless of their structural differences.

However, among the two units connected to the control unit, one is expected to have more signal lines than the other. When a common connector is used, the unit with fewer signal lines will have unused terminals where no signal line is connected. These unused terminals cause the insertion force to become uneven. Specifically, greater force is applied at the terminals with connected signal lines, while less force is applied at the unused terminals. This imbalance may cause one connector to tilt relative to the other, resulting in diagonal insertion and reduced assembly efficiency.

Such an image forming apparatus can detect connector connection failures but does not increase assembly efficiency between connectors. When a connector has unused terminals, the insertion force becomes uneven, leading to reduced assembly efficiency, as described above.

According to one aspect of the present disclosure, a connector module is provided that increases assembly efficiency between connectors is provided.

Referring to the attached drawings, each embodiment of this invention is described below. Like reference signs are applied to identical or corresponding components throughout the drawings and redundant description thereof may be omitted.

### Embodiment of Image Forming Apparatus

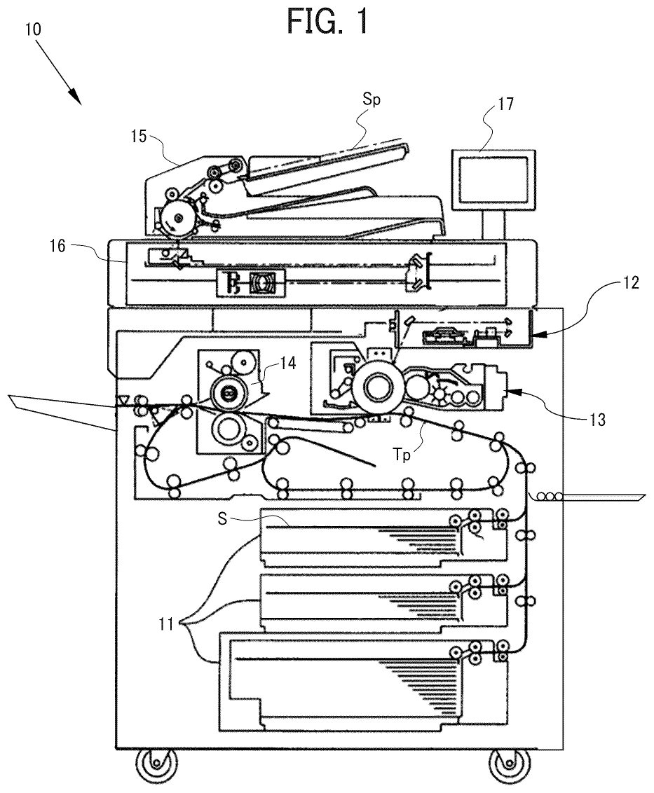

A description is given of another image forming apparatus according to an embodiment of the present disclosure. FIG. 1 is a front external view of an image forming apparatus 10. The image forming apparatus 10 forms images on sheets S as media using an electrophotographic method. Notably, the image forming apparatus 10 is not limited to the configuration exemplified in FIG. 1. For example, it is also possible to include a post-processing device in the image forming apparatus 10 as a single device configuration.

The image forming apparatus 10 includes a feeding unit 11, an optical writing unit 12, an image forming unit 13, a fixing unit 14, and a conveyance path Tp. The image forming apparatus 10 further includes an automatic document feeder (ADF) 15 and an image reading unit 16. The ADF 15 automatically supplies original documents Sp with images formed on them to the image reading unit 16. The image reading unit 16 optically reads the original documents Sp sent from the ADF 15. Additionally, the image forming apparatus 10 is equipped with an operation panel 17. The operation panel 17 serves as both a user interface for execution instructions, process conditions, and settings by the user, and an information display that displays the operational status of the image forming apparatus 10.

The conveyance path Tp conveys sheets S contained in the feeding unit 11 to the image forming unit 13. The feeding unit 11 includes multiple storage trays that contain sheets S and feeding roller pairs that feed the sheets S from each storage tray to the conveyance path Tp. The feeding unit 11 feeds a predetermined number of sheets S to the conveyance path Tp in response to an image formation process execution instruction.

The operation panel 17 is an operation input interface that instructs the operation of the image forming apparatus 10 and also functions as an information input interface for the user to set operation conditions and other settings for the image forming apparatus 10. The operation panel 17 includes a Graphical User Interface (GUI). When the start key is pressed to initiate the operation of the image forming apparatus 10, the image formation process is executed, forming images on sheets S, which are then output.

The image reading unit 16 optically reads original documents Sp placed on the ADF 15 using a Charge-Coupled Device (CCD) image sensor, performs photoelectric conversion, and outputs the result as read signals. The read signals are processed by an image processor and converted into image data. The image data is then stored in an image storage unit. The stored image data is read out, converted into control signals, and used for the operation of the optical writing unit 12.

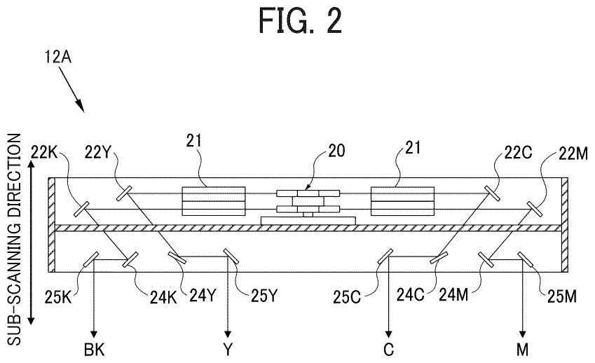

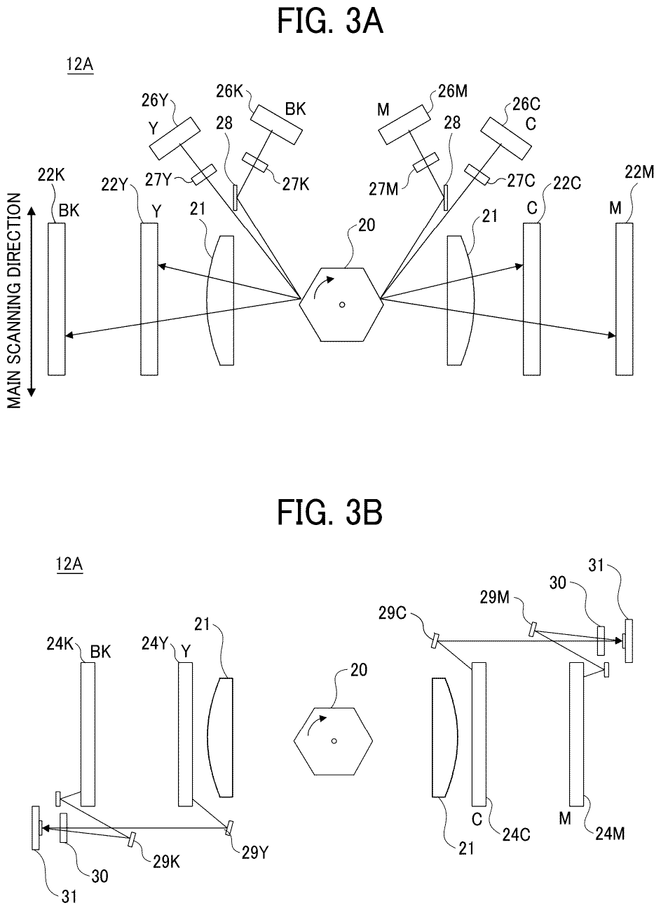

The optical writing unit 12 outputs laser beams that are optically modulated by control signals and forms latent images on the photoconductor drum of the image forming unit 13 using a polygon mirror 20 (see FIG. 2, FIGS. 3A and 3B) and other components.

The image forming unit 13 causes toner as a developing material to adhere to the latent images formed on the photoconductive drum through a developing device, forming toner images on the photoconductive drum. When the sheets S supplied from the feeding unit 11 are conveyed to the image forming unit 13 via the conveyance path Tp, the toner images formed on the photoconductive drum are transferred onto the sheets S.

The toner images transferred onto the sheets S are fixed to the sheets S by passing through the fixing unit 14. Through this series of processes, predetermined images are formed on the sheets S.

Notably, the image formation process in the image forming apparatus 10 is not only based on original documents Sp read by the image reading unit 16. For example, the image formation data can also be received from external devices, and the image forming apparatus 10 can execute image formation processes based on that data.

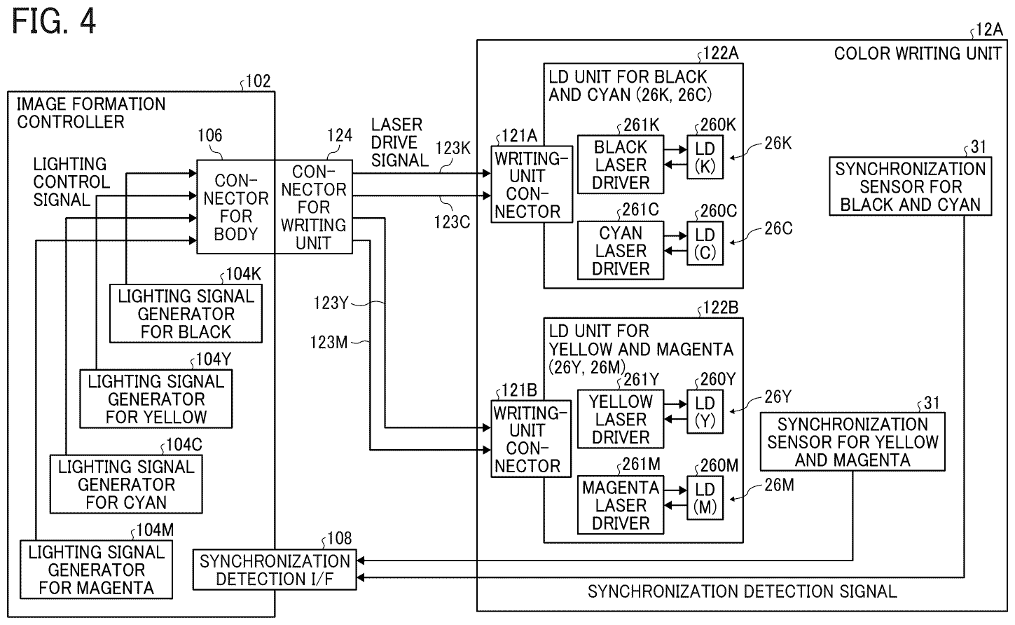

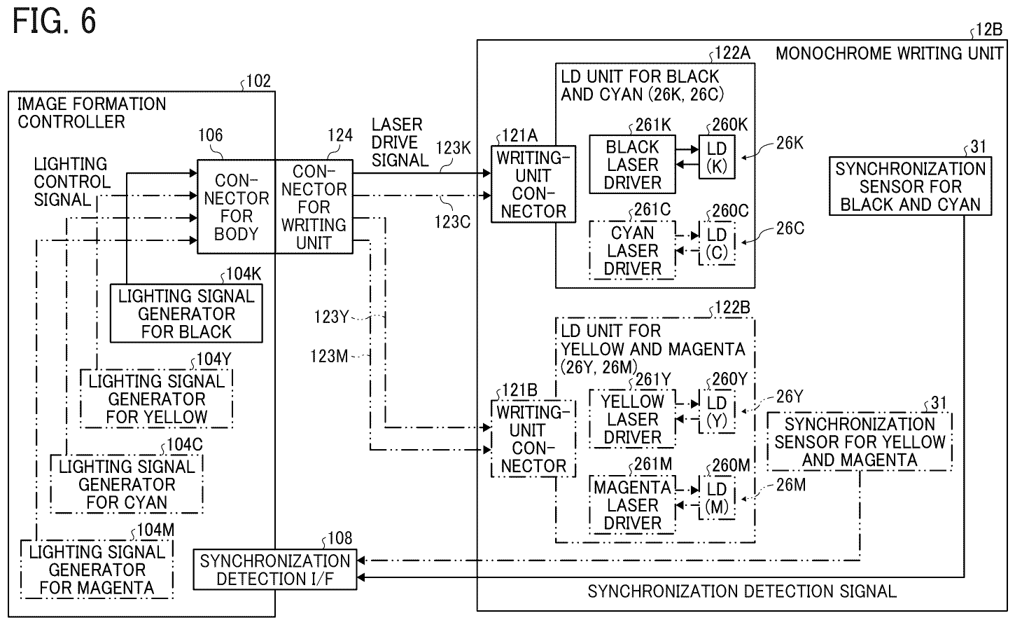

The optical writing unit 12 as a writing unit incorporates a connector module according to the present embodiment. The optical writing unit 12 includes either a color writing unit 12A or a monochrome writing unit 12B, and either one is connected to an image formation controller 102 (see FIGS. 4 and 6) of the image forming apparatus 10, depending on its specifications or design.

### Configuration of Color Writing Unit 12A

The configuration of the color writing unit 12A according to the present embodiment is described with reference to the drawings. FIG. 2 is a schematic configuration diagram illustrating a configuration of the color writing unit 12A. FIGS. 3A and 3B are schematic diagrams illustrating the configuration and operation examples of the color writing unit 12A.

The color writing unit 12A includes a polygon mirror 20, an f-θ lens 21, first mirrors 22C, 22M, 22Y, and 22K, second mirrors 24C, 24M, 24Y, and 24K, third mirrors 250, 25M, 25Y, and 25K, laser diode units 26C, 26M, 26Y, and 26K, cylindrical lenses 27C, 27M, 27Y, and 27K, and a reflection mirror 28. The color writing unit 12A forms color images of four colors: black (K), yellow (Y), cyan (C), and magenta (M).

In this specification, the direction in which the polygon mirror 20 deflects the laser beam that is perpendicular to the plane of the paper in FIG. 2 is defined as the main scanning direction, and the direction perpendicular to the main scanning direction in which the cylindrical lens 27 converges the laser beam is defined as the sub-scanning direction, which corresponds to the vertical (i.e., up-down) direction within the plane of the paper in FIG. 2. Additionally, the direction in which two f-θ lenses 21 are arranged with respect to the polygon mirror 20 is defined as the left-right direction, which corresponds to the horizontal direction within the plane of the paper in FIG. 2. Furthermore, when viewing the color writing unit 12A in the main scanning direction, the directions of up, down, left, and right are defined to match those on the plane of the paper in FIG. 2.

In the color writing unit 12A of the present embodiment, the polygon mirror 20 is placed at the center of the color writing unit 12A, and one polygon mirror 20 deflects laser beams of all four colors in the main scanning direction. The laser diode units 26C, 26M, 26Y, and 26K; first mirrors 22C, 22M, 22Y, and 22K; second mirrors 24C, 24M, 24Y, and 24K; third mirrors 25C, 25M, 25Y, and 25K; laser diode units 26C, 26M, 26Y, and 26K; cylindrical lenses 27C, 27M, 27Y, and 27K, and other components are arranged symmetrically to the left and right with the polygon mirror 20 at the center.

By arranging the optical paths for two colors of laser beams on each side of the polygon mirror 20, one polygon mirror 20 can deflect laser beams of all four colors. In the present embodiment, the optical paths for black and yellow are laid out on the left side of the polygon mirror 20, and the optical paths for cyan and magenta are laid out on the right side. The laser beams deflected by the polygon mirror 20 are then reflected by the first mirrors 22C, 22M, 22Y, and 22K.

The polygon mirror 20 is a rotating multi-faceted mirror. Specifically, the polygon mirror 20 has the shape of a hexagonal prism, and its outer peripheral surfaces function as deflecting and reflecting surfaces for the laser beams. The polygon mirror 20 is connected to a motor and rotates at high speed.

The laser diode units 26C, 26M, 26Y, and 26K are equipped with laser diodes that emit laser beams of cyan, magenta, yellow, and black, respectively.

The laser beams emitted from the laser diodes enter the cylindrical lenses 27C, 27M, 27Y, and 27K, respectively. The cylindrical lens 27 have a fixed refractive index in the sub-scanning direction and converges the laser beams emitted from the laser diode units 26C, 26M, 26Y, and 26K in the sub-scanning direction.

The cyan, magenta, yellow, and black laser beams converged by the cylindrical lenses 27C, 27M, 27Y, and 27K enter the deflection surfaces of the polygon mirror 20. The optical path of the cyan laser beam, converged by cylindrical lens 27C, is arranged to enter the right side of the polygon mirror 20. The optical path of the magenta laser beam, converged by cylindrical lens 27M, is reflected by the reflection mirror 28 before entering the right side of the polygon mirror 20.

The optical path of the yellow laser beam, converged by cylindrical lens 27Y, is arranged to enter the left side of the polygon mirror 20. The optical path of the black laser beam, converged by cylindrical lens 27K, is reflected by the reflection mirror 28 before entering the left side of the polygon mirror 20.

Among the laser beams of each color converged by the cylindrical lenses 27C, 27M, 27Y, and 27K, the cyan and magenta laser beams are directed to the right side of the polygon mirror 20, while the yellow and black laser beams are directed to the left side. These laser beams are then reflected by the deflection surfaces of the polygon mirror 20 and deflected in the main scanning direction.

Among the laser beams of each color deflected in the main scanning direction by the polygon mirror 20, the cyan and magenta laser beams enter an f-θ lens 21 located on the right side of the polygon mirror 20, and the yellow and black laser beams enter the f-θ lens 21 located on the left side of the polygon mirror 20.

The cyan laser beam is converged by the f-θ lens 21 and enters the first mirror 22C, which is located on the right side of the f-θ lens. The magenta laser beam is also converged by the f-θ lens 21, passes through the first mirror 22C, and enters the first mirror 22M, which is located further to the right of the first mirror 22C. The yellow laser beam is converged by the f-θ lens 21 and enters the first mirror 22Y on the left side of the f-θ lens. The black laser beam is also converged by the f-θ lens 21, passes through the first mirror 22Y, and enters the first mirror 22K, which is located further to the left of the first mirror 22Y.

The cyan, magenta, yellow, and black laser beams that enter the first mirrors 22C, 22M, 22Y, and 22K are reflected by the first mirrors 22C, 22M, 22Y, and 22K; the second mirrors 24C, 24M, 24Y, and 24K; and the third mirrors 25C, 25M, 25Y, and 25K; respectively, directing their optical paths downward from the color writing unit 12A. The photoconductor drum of the image forming unit 13 is positioned below the color writing unit 12A. The cyan, magenta, yellow, and black laser beams emitted from the color writing unit 12A form latent images on the photoconductor drum. As described above, the image forming unit 13 applies toner to these latent images. The resulting toner images are then transferred onto sheets S, forming the intended images on the sheets S.

As illustrated in FIG. 3B, the color writing unit 12A includes synchronization detection mirrors 29C, 29M, 29Y, and 29K, a synchronization detection lens 30, and a synchronization detection sensor 31.

Notably, in FIG. 3B, the first mirrors 22C, 22M, 22Y, and 22K; the third mirrors 25C, 25M, 25Y, and 25K; the laser diode units 26C, 26M, 26Y, and 26K; the cylindrical lenses 27C, 27M, 27Y, and 27K; and the reflection mirror 28 are omitted for simplicity.

The synchronization detection mirrors 29C and 29M are positioned on the right side of the polygon mirror 20, outside the second mirrors 24C and 24M in the main scanning direction. Similarly, the synchronization detection mirrors 29Y and 29K are positioned on the left side of the polygon mirror 20, outside the second mirrors 24C and 24M in the main scanning direction.

One synchronization detection lens 30 and one synchronization detection sensor 31 are arranged on each side of the polygon mirror 20. The synchronization detection lens 30 and the synchronization detection sensor 31 are positioned to receive the cyan and magenta laser beams reflected by the synchronization detection mirrors 29C and 29M. The synchronization detection lens 30 and the synchronization detection sensor 31 are positioned to receive the black and yellow laser beams reflected by the second mirrors 24Y and 24K.

When the cyan and magenta laser beams, converged by the f-θ lens 21 on the right side, are reflected at specific positions along the main scanning direction on the second mirrors 24C and 24M, the cyan and magenta laser beams enter the synchronization detection mirrors 29C and 29M, respectively. The cyan and magenta laser beams that enter the synchronization detection mirrors 29C and 29M are reflected by the synchronization detection mirrors 29C and 29M and directed into the synchronization detection lens 30 on the right side. The cyan and magenta laser beams that enter the synchronization detection lens 30 are then directed to the synchronization detection sensor 31 on the right side.

Similarly, when the yellow and black laser beams, converged by the f-θ lens 21 on the left side, are reflected at specific positions along the main scanning direction on the second mirrors 24Y and 24K, the cyan and magenta laser beams enter the synchronization detection mirrors 29Y and 29K, respectively. The yellow and black laser beams that enter the synchronization detection mirrors 29Y and 29K are directed to the synchronization detection lens 30 on the left side. The yellow and black laser beams that enter the synchronization detection lens 30 are then directed to the synchronization detection sensor 31 on the left side.

The synchronization detection sensor 31 detects the write start timing in the main scanning direction for each color's laser beam. One synchronization detection sensor 31 is used to detect the write start timing for two laser beam colors. That is, the synchronization detection sensor 31 positioned on the right side detects the write start timing in the main scanning direction for the cyan and magenta laser beams, whereas the synchronization detection sensor 31 on the left side detects the write start timing in the main scanning direction for the black and yellow laser beams. When the synchronization detection sensor 31 detects the write start timing in the main scanning direction for each color's laser beam, the synchronization detection sensor 31 sends synchronization detection signals to the image formation controller 102. The image formation controller 102 controls the operation of each unit, including the feeding unit 11, optical writing unit 12, image forming unit 13, and fixing unit 14 based on the synchronization detection signals.

### Hardware Configuration of Color Writing Unit 12A

A hardware configuration of a color writing unit 12A included in an image forming apparatus 10 is described below with reference to FIG. 4. As illustrated in FIG. 4, the image forming controller 102 includes lighting signal generators 104C, 104M, 104Y, and 104K, a connector 106 on the body side, and a synchronous detection interface (I/F) 108. The image formation controller 102 includes, for example, a central processing unit (CPU) as an operation unit. The image formation controller 102 controls the overall operation of the image forming apparatus 10.

The lighting signal generators 104C, 104M, 104Y, and 104K generate lighting control signals based on image data. The lighting signal generators 104C, 104M, 104Y, and 104K are connected to the connector 106.

The color writing unit 12A includes laser diode units 26C, 26M, 26Y, and 26K; synchronization detection sensors 31; writing-unit connectors 121A and 121B on the writing unit side; laser diode boards 122A and 122B; transmission signal lines 123C, 123M, 123Y, and 123K; and a connector 124 on the writing-unit side. The laser diode units 26C, 26M, 26Y, and 26K each include laser diodes 260C, 260M, 260Y, and 260K, and laser drivers 261C, 261M, 261Y, and 261K, respectively.

In the following description, the term “transmission signal line 123” is used when referring to transmission signal lines in general, without specifying color. When referring specifically to the transmission signal lines that carry laser drive signals for cyan, magenta, yellow, and black, the terms “transmission signal line 123C”, “transmission signal line 123M”, “transmission signal line 123Y”, and “transmission signal line 123K” are used, respectively.

For example, the laser diode units 26K and 26C are mounted on the laser diode board 122A, and the laser diode units 26Y and 26M are mounted on the laser diode board 122B. The laser diode units 26K and 26C are electrically connected to the writing-unit connector 121A. The writing-unit connector 121A is fixed to the laser diode board 122A. Similarly, the laser diode units 26Y and 26M are electrically connected to the writing-unit connector 121B. The writing-unit connector 121B is fixed to the laser diode board 122B.

The writing-unit connectors 121A and 121B are connected to the connector 124 via transmission signal lines 123C, 123M, 123Y, and 123K. The transmission signal lines 123C, 123M, 123Y, and 123K are electrically connected to the laser diode units 26C, 26M, 26Y, and 26K, respectively.

The connector 124 on the writing unit side is electrically and physically connected to the connector 106 on the body side. That is, the image formation controller 102 is electrically connected to the laser diode units 26C, 26M, 26Y, and 26K. This allows the lighting control signals generated by the lighting signal generators 104C, 104M, 104Y, and 104K to be output as laser drive signals to the laser diode units 26C, 26M, 26Y, and 26K. The laser drivers 261C, 261M, 261Y, and 261K, upon receiving the laser drive signals, respectively drive the corresponding laser diodes 260C, 260M, 260Y, and 260K to emit laser beams of cyan, magenta, yellow, and black, respectively. The “physical connection” between the connector 124 and the connector 106 refers to, for example, a state in which the two connectors are fitted together and form a unified structure.

Additionally, the synchronization detection sensor 31 is connected to the synchronization detection I/F 108. The synchronization detection I/F 108 can send and receive signals to and from the synchronization detection sensor 31 through either wired or wireless communication. The synchronization detection sensor 31 sends synchronization detection signals to the image formation controller 102 through the synchronization detection I/F 108.

### Configuration of Monochrome Writing Unit According to Comparative Example

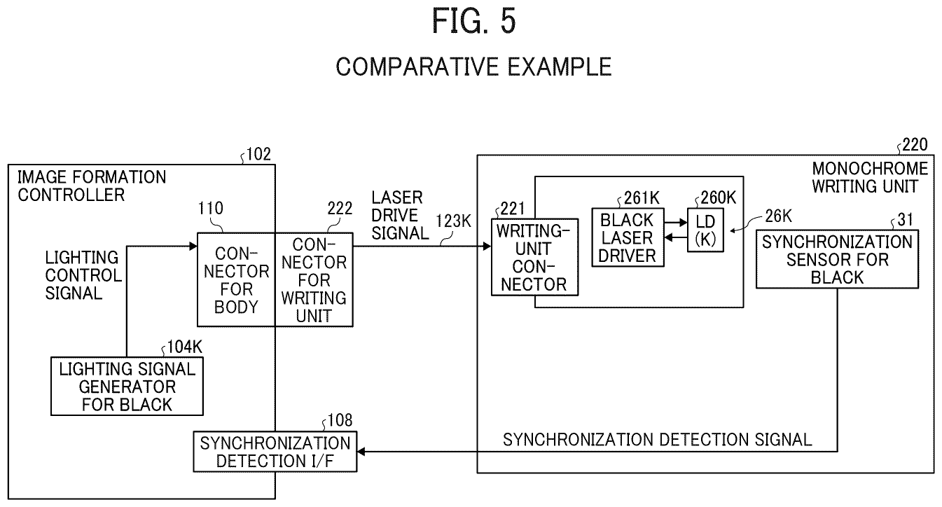

As illustrated in FIG. 5, a monochrome writing unit 220 according to a comparative example includes a black laser diode unit 26K, a synchronization detection sensor 31, a writing-unit connector 221, a transmission signal line 123K, and a connector 222 on the writing-unit side. The black laser diode unit 26K is connected to the writing-unit connector 221. Furthermore, the synchronization detection sensor 31 includes a single sensor that detects the write start timing of the black laser beam.

The writing unit connector 221 is connected to the connector 222 via the transmission signal line 123K. The transmission signal line 123K is electrically connected to the laser diode unit 26K.

The connector 222 is electrically connected to a connector 110 on the body side, thus electrically connecting the image formation controller 102 to the laser diode unit 26K. This connection allows a lighting control signal generated by a lighting signal generator 104K to be output as a laser drive signal to the laser diode unit 26K. The laser drive signal then drives a laser diode 260K to emit a black laser beam.

In the monochrome writing unit 220 of FIG. 5, only the transmission signal line 123K is connected to the connector 222, and the connection terminal is solely for the transmission signal line 123K. The connector 222 on the writing unit side cannot be shared with the color writing unit 12A, which includes multiple transmission signal lines 123C, 123M, 123Y, and 123K and corresponding terminals.

However, in the present embodiment, parts or components are shared between the color writing unit 12A and the monochrome writing unit 12B. As described in detail below, the monochrome writing unit 12B is derived from the configuration of the color writing unit 12A by removing or disabling the signal lines for yellow, cyan, and magenta, as well as the laser diode units 26Y, 26C, and 26M. This allows the monochrome writing unit 12B to share parts with the color writing unit 12A, while maintaining the functionality to form a single-color (i.e., black) image. The connector is also shared between the color writing unit 12A and the monochrome writing unit 12B.

### Hardware Configuration of Color Writing Unit 12A

The hardware configuration of the monochrome writing unit 12B according to an embodiment of the present disclosure is described with reference to FIG. 6. In FIG. 6, the monochrome writing unit 12B includes a laser diode unit 26K, a synchronization detection sensor 31, and writing-unit connectors 121 and 122. These components have the same configuration as those in the color writing unit 12A described above. However, the transmission signal lines 123C, 123M, and 123Y for cyan, magenta, and yellow, as well as the laser diode units 26C, 26M, and 26Y, have been removed or disabled. In FIG. 6, the functional blocks indicated by dash-dot lines represent the components that have been removed or disabled.

In the present disclosure, “disabling/disabled” components of the monochrome writing unit 12B refers to actions such as physically cutting signal lines, removing parts, or disabling them through software by changing settings.

In the monochrome writing unit 12B, the laser diode units 26C, 26M, and 26Y are removed or disabled, allowing only the black laser diode unit 26K to be used. That is, the monochrome writing unit 12B is designed solely to form black images. In the present embodiment, the lighting signal generators 104C, 104M, and 104Y connected to the connector 106 may also be removed or disabled.

In other words, the lighting signal generators 104C, 104M, and 104Y may be configured not to output lighting control signals.

As described above, in the monochrome writing unit 12B, the laser diode units 26C, 26M, and 26Y are removed or disabled. The other parts are the same as those in the color writing unit 12A. Specifically, the laser diode unit 26C is removed or disabled, and the laser diode unit 26K, which is in use, is mounted on the laser diode board 122A, just as in the color writing unit 12A. The connector 124 on the writing-unit side is shared by both the color writing unit 12A and the monochrome writing unit 12B, and can be used as-is to connect with the connector 106.

### Configuration of Connector Modules 130A and 130B

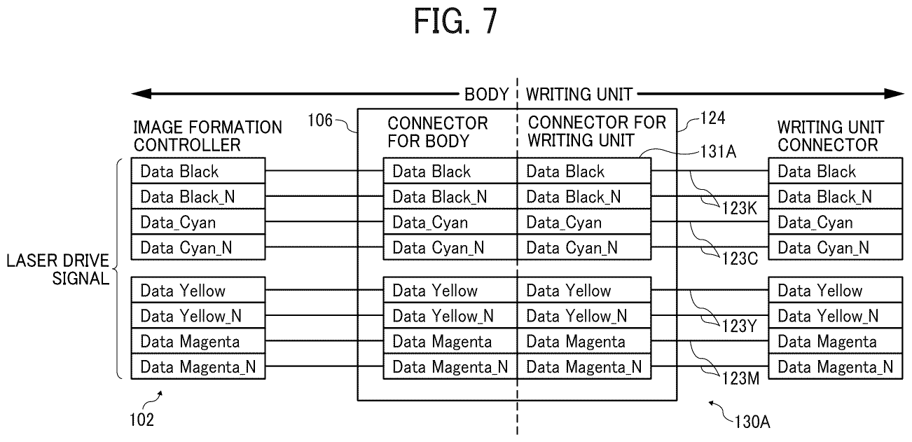

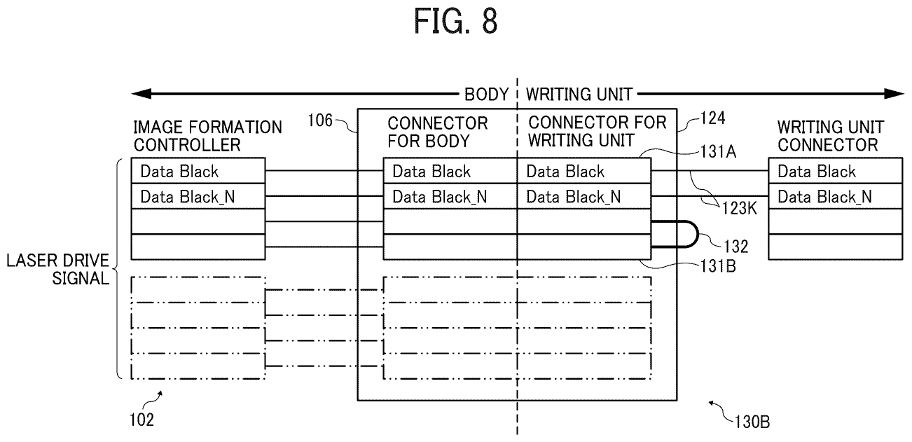

FIG. 7 is a diagram illustrating a configuration of a connector module 130A according to an embodiment of the present disclosure. FIG. 8 is a diagram illustrating a configuration of a connector module 130B according to an embodiment of the present disclosure. The connector module 130A is used for the color writing unit 12A, while the connector module 130B is used for the monochrome writing unit 12B.

When the color writing unit 12A is used in the image forming apparatus 10, all transmission signal lines 125C, 125M, 125Y, and 125K for cyan, magenta, yellow, and black are used. As such, more transmission signal lines are used than in the monochrome writing unit 12B. In other words, the monochrome writing unit 12B uses fewer transmission signal lines than the color writing unit 12A. When the connector 124 on the writing-unit side is shared between the color writing unit 12A and the monochrome writing unit 12B and used in the connector module 130B for the monochrome writing unit 12B, the connector 124 holds multiple connection terminals, including unused connection terminals (or second connection terminals) that are not used for transmitting laser drive signals.

The connector module 130A for the color writing unit 12A includes a connector 124, multiple used connection terminals 131A (or a first connection terminal), and transmission signal lines 123C, 123M, 123Y, and 123K. The used connection terminals 131A are used for transmitting laser drive signals. Each of the transmission signal lines 123C, 123M, 123Y, and 123K is formed of a pair of lines—one carrying a positive voltage and the other a negative voltage—to transmit signals via potential difference. These used connection terminals 131A are held by the connector 124. In FIG. 7, the connector 124 holds eight used connection terminals 131A, corresponding to the number of transmission signal lines.

The connector module 130B for the monochrome writing unit 12B includes a connector 124, transmission signal lines 123K, used connection terminals 131A, unused connection terminals 131B, and a bent signal line 132. As described above, since transmission signal lines 123C, 123M, and 123Y are unused or removed, only the transmission signal lines 123K are used for transmitting laser drive signals in the connector module 130B. The transmission signal lines 123K each are formed of a pair of signal lines—one carrying a positive voltage and the other a negative voltage—to transmit signals via potential difference. The used connection terminals 131A are held by the connector 124. In FIG. 8, the connector 124 holds two used connection terminals 131A, corresponding to the transmission signal lines 123K.

The unused connection terminals 131B are held by connector 124 and are not used for transmitting laser drive signals. As illustrated in FIG. 8, these unused connection terminals 131B are located where the used connection terminals 131A for cyan are positioned in the connector module 130A for the color writing unit 12A. This is because, as described above, the transmission signal lines 123C, 123M, and 123Y are unused or removed. The bent signal line 132 is connected to the unused connection terminals 131B. Details of the bent signal line 132 are described later.

In a connector module for a monochrome writing unit according to a comparative example, only the transmission signal lines 123K are connected to the connector on the writing-unit side, and only the corresponding connection terminals are present, making it difficult to share the connector.

In contrast, the connector module 130B uses unused connection terminals 131B to match the number of connection terminals more closely with those in the connector 106, allowing the connector 124 to be shared between the color writing unit 12A and the monochrome writing unit 12B.

### First Embodiment of Connector Module 130B

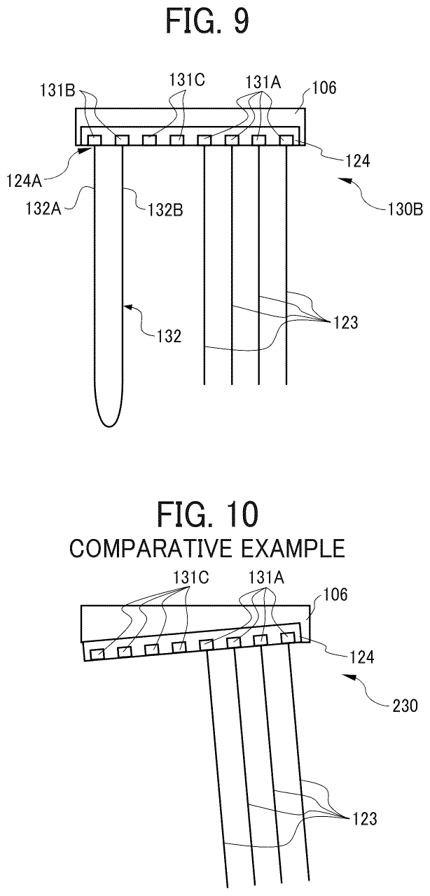

FIG. 9 is a plan view of a connector module 130B. The connector module 130B for the monochrome writing unit 12B includes a connector 124 on the writing-unit side, transmission signal lines 123, used connection terminals 131A, unused connection terminals 131B, and a bent signal line 132. The connector 124 has both the used connection terminals 131A and the unused connection terminals 131B arranged in a straight line or row. In FIG. 9, the connector 124 has eight connection terminals arranged in the row 124A, including four used connection terminals 131A and two unused connection terminals 131B.

At least one unused connection terminal 131B is located at one end of row 124A. In FIG. 9, the two unused terminals 131B are arranged in sequence from one end of the row 124A, while the four used terminals 131A are arranged from the opposite end. The connector 124 also has empty terminals 131C at the third and fourth positions from one end of the row 124A, which are not connected to either the transmission signal lines or the bent signal line 132. However, this configuration is not restrictive, and the bent signal line 132 may alternatively be connected to the terminals at the third and fourth positions from one end.

The bent signal line 132 is at least partially bent in a U-shape, with both ends 132A and 132B extending toward the connector. Each of the ends 132A and 132B is connected to a unused connection terminal 131B. The transmission signal lines 123, which transmit drive signals, are connected to the used connection terminals 131A.

When the connector module 130B is connected to the connector 106, the transmission signal lines 123 and the bent signal line 132 are gripped to physically connect the connector 124 and the connector 106. This establishes an electrical connection between the image formation controller 102 and the laser diode units 26C, 26M, 26Y, and 26K.

According to the present embodiment, since the bent signal line 132 is connected to the unused connection terminals 131B, the transmission signal lines 123 and the bent signal line 132 are gripped, enabling a reliable connection between connector 124 and connector 106. This enhances assembly efficiency between the connector 124 and the connector 106.

FIG. 10 is a block diagram of a configuration of a connector module 230 according to a comparative example. As in the connector module 230 illustrated in FIG. 10, if the bent signal line 132 is not provided, force is concentrated around the gripping of the transmission signal lines 123. This causes the connector 124 to tilt relative to the connector 106, resulting in a diagonal insertion. However, the connector module 130B of the present embodiment prevents diagonal insertion by connecting the bent signal line 132 to the unused connection terminals 131B.

Additionally, since the bent signal line 132 is connected to the unused connection terminals 131B at one end of the connector 124, the connector 124 is connected to the connector 106 while being gripped near that end. As a result, force is distributed more evenly between both ends of connector 124, enhancing assembly efficiency between the connector 124 and the connector 106.

### Second Embodiment of Connector Module 130B

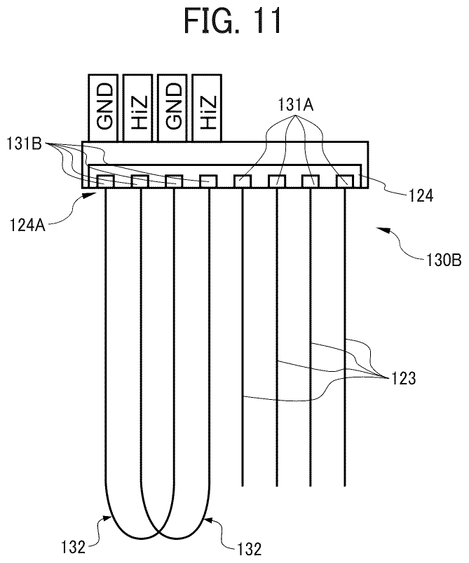

A connector module according to a second embodiment of the present disclosure is described below. FIG. 11 is a plan view of a connector module 130B. The connector module 130B has two bent signal lines 132. One bent signal line 132 has its ends connected to unused connection terminals 131B at the first and third positions from one end of the row 124A. Another bent signal line 132 has its ends connected to unused connection terminals 131B at the second and fourth positions from one end of the row 124A. That is, the ends of two bent signal lines 132 are connected alternately to unused connection terminals 131B from one end of the row 124A.

In FIG. 11, the connector 106 on the body side has both ground potential (GND) and high impedance (HiZ) connections. HiZ refers to an electrically insulated state, meaning a component with a high resistance value. GND is connected at the first and third positions from one end of the connector 106, whereas HiZ is connected at the second and fourth positions from the same end. These positions correspond to those of the bent signal lines 132.

In other words, the second connection terminals (e.g., the unused connection terminals 131B) have two terminals connected to ground potential, and both ends of the bent signal line 132 are respectively connected to the tow terminals. The second connection terminals have other two terminals connected to a part having impedance higher than ground potential, and both ends of the bent signal line 132 are respectively connected to the other two terminals. The two terminals and the other two terminals are alternately arrayed in a line on the connector.

According to the present embodiment, as in the first embodiment, the bent signal lines 132 are connected to unused connection terminals 131B, which enhances assembly efficiency between the connector 124 and the connector 106. Further, when the connector module 130B is connected to the connector 106, one bent signal line 132 is connected to GND at both ends, and another bent signal line 132 is connected to HiZ at both ends (or another bent signal line 132 is in a HiZ state at both ends). This prevents potential differences from occurring across the bent signal lines 132.

If potential differences occur at both ends of the bent signal lines 132, current flows through the bent signal lines 132, generating noise. However, in the present embodiment, such potential differences are eliminated, thus preventing noise.

### Third Embodiment of Connector Module 130B

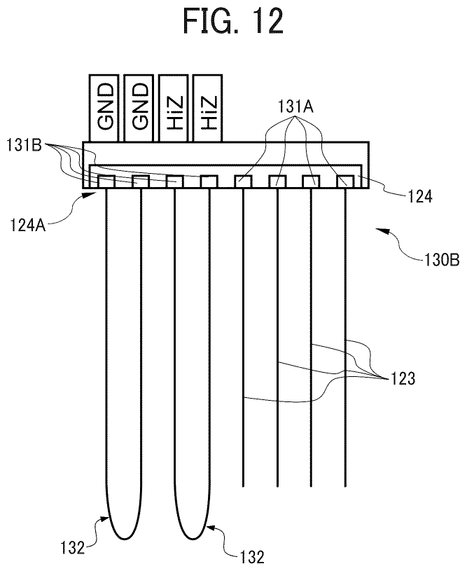

A connector module according to a third embodiment of the present disclosure is described below. FIG. 12 is a plan view of a connector module 130B. In the present embodiment, both ends of each bent signal line 132 are connected to adjacent unused connection terminals 131B.

Specifically, one bent signal line 132 has both its ends connected to unused connection terminals 131B, which are the first and second terminals from one end of row 124A. Another bent signal line 132 has both its ends connected to unused connection terminals 131B, which are the third and fourth terminals from one end of the row 124A. That is, from one end of row 124A, the ends of one bent signal line 132 and the ends of another bent signal line 132 are connected in sequence to unused connection terminals 131B.

In FIG. 12, the connector 106 on the body side has both GND and HiZ connections. GND is connected at the first and second positions from one end of the connector 106, whereas HiZ is connected at the third and fourth positions from the same end. These positions correspond to those of the bent signal lines 132.

When the connector module 130B is connected to the connector 106, as in the second embodiment, one bent signal line 132 is connected to GND at both ends, and another bent signal line 132 is connected to HiZ at both ends (or another bent signal line 132 is in a HiZ state at both ends). This prevents potential differences from occurring across the bent signal lines 132, thus reducing noise.

In other words, the second connection terminals (e.g., unused connection terminals 131B) have two terminals connected to ground potential, and both ends of the bent signal line 132 are respectively connected to the two terminals. The two terminals are arrayed in a line (or the row 124A) on the connector; and adjacent to each other in the line.

The second connection terminals have two terminals, each of which is connected to a part having impedance higher than ground potential, and both ends of the bent signal line are respectively connected to the two terminals. The two terminals are arrayed in a line (or the row 124A) on the connector; and adjacent to each other in the line.

Additionally, the bent signal lines 132 may be connected to either non-adjacent unused connection terminals 131B, as in the second embodiment, or adjacent unused connection terminals 131B, as in the present embodiment. This allows for a high degree of design flexibility.

The above-described embodiments are illustrative and do not limit the present disclosure. Thus, numerous additional modifications and variations are possible in light of the above teachings. For example, elements and/or features of different illustrative embodiments may be combined with each other and/or substituted for each other within the scope of the present disclosure.

Aspects of the disclosure are, for example, as follows.

### Aspect 1

A connector module includes a connector having multiple connection terminals including: a first connection terminal to transmit a drive signal; and second connection terminals not used to transmit the drive signal; a transmission signal line connected to the first connection terminal to transmit the drive signal to the first connection terminal; and a bent signal line connected to the second connection terminals. The bent signal line has both ends connected to the second connection terminals; and a fold part between the both ends.

### Aspect 2

In the connector module according to Aspect 1, the first connection terminal and the second connection terminals are arrayed in a line on the connector, and at least one of the second connection terminals is positioned at one end of the line.

### Aspect 3

In the connector module according to Aspect 1 or 2, the second connection terminals have two terminals connected to ground potential, and the both ends of the bent signal line are respectively connected to the two terminals.

### Aspect 4

In the connector module according to Aspect 3, the two terminals are: arrayed in a line on the connector; and adjacent to each other in the line.

### Aspect 5

In the connector module according to Aspect 1 or 2, the second connection terminals have two terminals, each of which is connected to a part having impedance higher than ground potential. Both ends of the bent signal line are respectively connected to the two terminals.

### Aspect 6

In the connector module according to Aspect 5, the two terminals are: arrayed in a line on the connector; and adjacent to each other in the line.

### Aspect 7

In the connector module according to Aspect 1 or 2, the second connection terminals have two terminals connected to ground potential. Both ends of the bent signal line are respectively connected to the two terminals. The second connection terminals have other two terminals connected to a part having impedance higher than ground potential, and both ends of the bent signal line are respectively connected to the other two terminals.

### Aspect 8

In the connector module according to Aspect 7, the two terminals and the other two terminals are alternately arrayed in a line on the connector.

### Aspect 9

A writing unit includes the connector module according to any one of Aspects 1 to 8; and a laser diode unit connected to the first connection terminal to receive the drive signal through the transmission signal line.

### Aspect 10

An image forming apparatus includes the writing unit according to Aspect 9; and circuitry configured to transmit the drive signal to the laser diode unit through the transmission signal line and the first connection terminal.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

1. A connector module comprising:
a connector having multiple connection terminals including:
a first connection terminal to transmit a drive signal; and
second connection terminals not used to transmit the drive signal;
a transmission signal line connected to the first connection terminal to transmit the drive signal to the first connection terminal; and
a bent signal line connected to the second connection terminals, the bent signal line having:
both ends connected to the second connection terminals; and
a fold part between the both ends.

2. The connector module according to claim 1, wherein
the first connection terminal and the second connection terminals are arrayed in a line on the connector, and
at least one of the second connection terminals is positioned at one end of the line.

3. The connector module according to claim 1, wherein
the second connection terminals have two terminals connected to ground potential, and
the both ends of the bent signal line are respectively connected to the two terminals.

4. The connector module according to claim 3, wherein
the two terminals are:
arrayed in a line on the connector; and
adjacent to each other in the line.

5. The connector module according to claim 1, wherein
the second connection terminals have two terminals, each of which is connected to a part having impedance higher than ground potential, and
the both ends of the bent signal line are respectively connected to the two terminals.

6. The connector module according to claim 5, wherein
the two terminals are:
arrayed in a line on the connector; and
adjacent to each other in the line.

7. The connector module according to claim 1, wherein
the second connection terminals have two terminals connected to ground potential,
the both ends of the bent signal line are respectively connected to the two terminals,
the second connection terminals have other two terminals connected to a part having impedance higher than ground potential, and
the both ends of the bent signal line are respectively connected to the other two terminals.

8. The connector module according to claim 7, wherein
the two terminals and the other two terminals are alternately arrayed in a line on the connector.

9. A writing unit comprising:
the connector module according to claim 1; and
a laser diode unit connected to the first connection terminal to receive the drive signal through the transmission signal line.

10. An image forming apparatus comprising:
the writing unit according to claim 9; and
circuitry configured to transmit the drive signal to the laser diode unit through the transmission signal line and the first connection terminal.
